(19) United States
(12) Patent Application Publication
(10) Pub. No.: US 2021/0342211 A1
(43) Pub. Date: Nov. 4, 2021

(54) FAULT PREDICTION MODEL TRAINING WITH AUDIO DATA

(71) Applicants: Hewlett-Packard Development Company, L.P., Spring, TX (US); INSTITUTO ATLANTICO, Fortaleza (BR)

(72) Inventors: Tiago Barbosa Melo, Fortaleza (BR); Claudio Andre Heckler, Porto Alegre (BR)

(73) Assignees: Hewlett-Packard Development Company, L.P., Spring, TX (US); INSTITUTO ATLANTICO, Fortaleza (BR)

(21) Appl. No.: 17/262,769

(22) PCT Filed: Jan. 21, 2019
(86) PCT No.: PCT/US2019/014404

§ 371 Date: Jan. 25, 2021

(51) Int. Cl. G06F 11/07; G06N 20/00; G06F 3/12

(52) U.S. Cl. CPC G06F 11/079; G06F 11/0751; G06F 3/121; G06F 3/1224; G06N 20/00

(57) ABSTRACT

Examples of methods for fault prediction model training with audio data are described herein. In some examples, service event data and audio data corresponding to client devices are received. In some examples, a portion of the audio data is selected based on the service event data. In some examples, a machine learning model is trained for fault prediction based on the portion of audio data.

### BACKGROUND

Devices can fail or operate poorly over time. For instance, device components may wear down to the point of failure or may be manufactured with defects that cause failure. In some cases, devices can be configured improperly, which can lead to failure or poor operation. Device failure or poor operation can incur costs. For example, device servicing, component replacement, and/or operation downtime can result in significant costs.

### BRIEF DESCRIPTION OF THE DRAWINGS

FIG. 1 is a flow diagram illustrating an example of a method for fault prediction model training with audio data;

FIG. 2 is a block diagram of an example of an apparatus that may be used in fault prediction model training with audio data;

FIG. 3 is a block diagram illustrating an example of a computer-readable medium for performing fault prediction model training with audio data;

FIG. 4 is a block diagram illustrating an example of an apparatus and a plurality of client devices; and

FIG. 5 is a thread diagram of an example of an apparatus and client devices.

### DETAILED DESCRIPTION

Service events originating from device faults may be costly for a party providing service as well as for the party of the impacted device. A service event is an event where a resource or resources (e.g., technician dispatch, replacement part shipment, support advice, etc.) is or are expended to remedy a fault. A fault is a failure, error, disruption, degradation, or lapse in the operation of a device. Examples of faults include operation failures, part failures, device breakdowns, operation interruptions, misconfigurations, crashes, degraded performance, reduced performance, etc.

Predicting faults before they occur can allow preventive maintenance to be executed before a fault happens, for example, while a device's part is in a degraded state but before complete failure. Predicting faults may save resources (e.g., may avoid downtime, save money, save man-hours, etc.) for the device's user and the service provider through better maintenance planning. Such predictive capabilities may be particularly beneficial for devices (e.g., large-format printers) in which downtime of even minutes has a direct financial impact. Examples of some of the techniques described herein may be applied to commercial devices and/or consumer devices.

Some examples of the techniques described herein may relate to fault prediction model training with audio data. For example, fault prediction may be enabled based on audio data and other information (e.g., service event data, operating state). Anticipating faults can be improved with audio data analysis techniques that compare audio data from target device operations with audio data from degraded device operations.

Throughout the drawings, identical reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

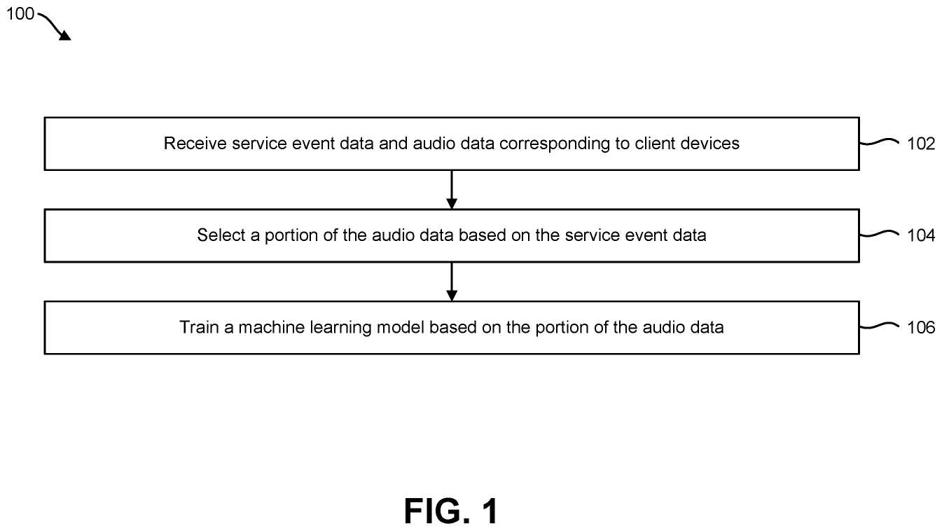

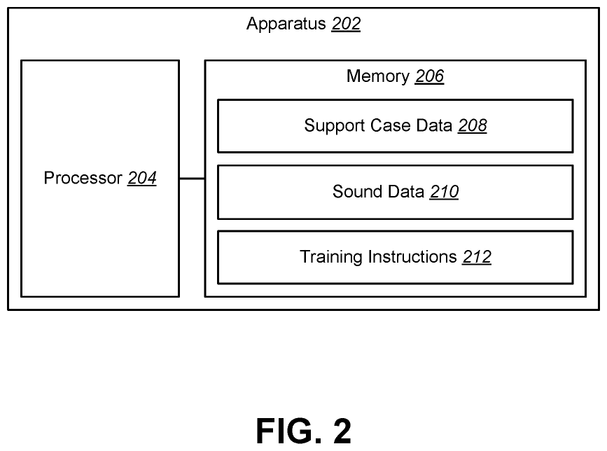

FIG. 1 is a flow diagram illustrating an example of a method 100 for fault prediction model training with audio data. The method 100 and/or a method 100 element or elements may be performed by an apparatus (e.g., electronic device). For example, the method 100 may be performed by the apparatus 202 described in connection with FIG. 2.

The apparatus may receive 102 service event data and audio data corresponding to client devices. A device is an electronic and/or mechanical device configured to perform an operation or operations. Examples of devices include printers (e.g., inkjet printers, laser printers, 3D printers, etc.), copiers, desktop computers, laptop computers, game consoles, vehicles, aircraft, motors, furnaces, air conditioning units, power tools, fans, appliances, refrigerators, generators, musical instruments, robots, drones, actuators, farming equipment, etc. A client device is a device that is monitored by the apparatus. In some examples, a client device may be in communication with the apparatus. For example, the client device may communicate with the apparatus via a network (e.g., a local area network (LAN), wide area network (WAN), the Internet, cellular network, Long Term Evolution (LTE) network, etc.) and/or a link or links (e.g., wired link(s) and/or wireless link(s)). A remote client device is a client device that is located remotely (e.g., more than 5 feet) from the apparatus.

Service event data is data indicating a service event and/or information about a service event. As described above, a service event is an event where a resource or resources (e.g., technician dispatch, replacement part shipment, support advice, etc.) is or are expended (or planned to be expended) to remedy a fault. Examples of service event data may include a service event indicator that indicates whether a service event has occurred, service event date, service event time, service event corrective action (e.g., action taken to remedy a fault, such as whether a technician was dispatched, whether a part was replaced, a type of part that was replaced, whether the device was adjusted, how the device was adjusted, whether the fault was remedied by a contact from a support person, etc.), device (e.g., client device) identifier, device type identifier (e.g., client device model), etc.

In some examples, the service event data may be stored in a database. For example, client devices serviced by a provider (under a managed print services (MPS) contract, for instance) may have a history of service events per model of client device. When a service event occurs, for example, the service event data (e.g., client device model, revision, installed features, etc.), the type of fault identified (e.g., paper pick-up mechanism jamming), and/or any corrective action taken may be captured and stored as service event data. In some examples, the service event data may be stored with audio data (e.g., anonymized audio data).

In some examples, the apparatus may receive 102 some or all of the service event data from the client device. For example, the client device may determine and/or store the service event data, which may be sent to the apparatus. For instance, the client device may automatically detect service event data (e.g., replaced part(s), configuration adjustment(s), etc.) and may send the service event data to the apparatus. In another example, the client device may receive the service event data via a user interface. For instance, a technician may input service event data into the client device, which may send the service event data to the apparatus.

In some examples, the apparatus may receive 102 some or all of the service event data from another device (e.g., from a separate computer or server, from a device that is not the client device, etc.). For example, a service provider (e.g., technician) may enter service event data on a device (e.g., smart phone, laptop computer, desktop computer, server, etc.), which may send the service event data to the apparatus.

Audio data is data representing vibrations or a quantification of vibrations. Vibrations may or may not be audible. Examples of audio data include electronically captured (e.g., sampled) audio signals, transformed audio signals (e.g., audio signals that have undergone processing, one or more transformations, filtering, etc.), features based on audio signals, audio signatures, etc. As used herein, “sound data” is an example of audio data that represents audible vibrations or that is based on audible vibrations.

In some examples, the apparatus may receive 102 some or all of the audio data from the client device. For example, the client device may capture, determine, and/or store the audio data, which may be sent to the apparatus. For instance, the client device may include a sensor or sensors (e.g., vibration sensor(s), microphone(s)) to capture audio signals (e.g., mechanical vibrations and/or acoustic signals). In some examples, the client device may digitally sample captured audio signals to produce digital audio signals. In some examples, the audio signals may be sent as the audio data. In some examples, the client device may perform one or more operations on the audio signal(s) to produce the audio data. For example, the client device may perform digital signal processing and/or a transformation or transformations on the audio signal(s) to produce the audio data. For instance, the client device may produce an audio signature or signatures by performing the processing and/or transformation(s). An audio signature is data that characterizes an audio signal. Examples of audio signatures include frequency peaks, signal envelopes, wave periods, energy distribution, etc. A frequency peak may be a frequency at which a transformed audio signal is the highest and/or a frequency at which a transformed audio signal is the highest above a threshold. The client device may send the audio data to the apparatus.

In some examples, the digital signal processing and/or the transformation or transformations performed by a client device may be performed to improve privacy. For example, the digital signal processing and/or transformation(s) may modify an audio signal (which may be considered sensitive) into an anonymized derivative of the audio signal. In some examples, the audio signature(s) may be anonymized derivatives of the audio signal. The resulting audio data may be sent to the apparatus.

In some examples, another device may send the audio data to the apparatus. For example, a device may be attached to the client device, mounted on the client device, integrated into the client device, or may be located near the client device (e.g., within a threshold distance from the client device, such as within three feet). The device may capture audio signals (e.g., vibrations and/or acoustic signals) using a sensor or sensors. For instance, the device may digitally sample captured audio signals to produce digital audio signals (which may be sent as the audio data in some examples). In some examples, the device may perform one or more operations on the audio signal(s) to produce the audio data, such as digital signal processing, wave filtering, and/or a transformation or transformations on the audio signal(s) to produce the audio data. For instance, the device may produce an audio signature or signatures by performing the processing and/or transformation(s). The device may send the audio data to the apparatus. Accordingly, the apparatus may receive 102 some or all of the audio data from client device(s) and/or another device(s). In some examples, the audio data is additionally or alternatively fed into a machine learning model (e.g., neural network model) for classification.

The apparatus may select 104 a portion of the audio data based on the service event data. In some examples, selecting 104 the portion of the audio data includes selecting a portion of the audio data within a period of time from a service event. For example, the apparatus may select 104 a portion of the audio data corresponding to a client device that had a service event within a period from a time of the service event (e.g., two hours, four hours, ten hours, a day, two days, a week, etc.). In some examples, selecting 104 the portion of the audio data may include selecting a portion of the audio data corresponding to one client device (e.g., the client device with the service event as indicated by the service event data).

The apparatus may train 106 a machine learning model for fault prediction based on the portion of audio data. Fault prediction is forecasting whether or not (e.g., a likelihood that) a fault will occur in a device or devices. A model is a machine learning model. In some examples, the machine learning model may be a machine learning classification model that classifies an input or inputs to produce a fault prediction. Examples of machine learning models include classification algorithms (e.g., supervised classifier algorithms), artificial neural networks, decision trees, random forests, support vector machines, Gaussian classifiers, k-nearest neighbors (KNN), etc. In some examples, the machine learning model may include and/or utilize combinations or ensembles of algorithms to improve the machine learning model. Accordingly, a fault prediction model is a machine learning model for performing fault prediction.

In some examples, a machine learning model may be trained 106 with audio data for fault prediction. The machine learning model may be trained 106 using the portion of audio data (preceding the service event, for instance) to classify audio data as predicting the fault. For example, the portion of audio data may be utilized as training data to adjust weights in a neural network. In some examples, the machine learning model may also be trained with other audio data (e.g., other portions of audio data) where a fault did not occur (e.g., under normal operation). As used herein, “normal operation” and variants thereof may denote operation in which a device operates in accordance with a baseline or target operation (e.g., without a fault, without major issue such as a component failure, breakdown, and/or without significant downtime due to a problem with operation). For example, other audio data may be selected as audio data from a same client device model (and revision, for instance) that has not had a fault reported for a period of time (e.g., for three months after the corresponding audio signal was captured).

In some examples, the apparatus may transmit the trained machine learning model to the client devices. For example, the apparatus may send machine learning model data to the client devices over a network and/or using wired and/or wireless link(s). The client devices may utilize the machine learning model to predict a fault. For example, a client device may capture and/or determine test audio data. The test audio data may be provided to the machine learning model. The machine learning model may predict a fault based on the test audio data. For example, the machine learning model may classify the test audio data as predicting a fault or as not predicting a fault. In some examples, the machine learning model may produce a likelihood that a fault will occur based on the test audio data. In some examples, a client device may initially include a machine learning-model (e.g., a pre-trained machine learning model loaded during manufacture). The machine learning model trained by the apparatus may be utilized to update the initial machine learning model in some examples.

In some examples, the trained machine learning model may be utilized on a server. For example, the apparatus may be a server or the apparatus may send the trained machine learning model to a server over a network and/or using wired and/or wireless link(s). The server may utilize the machine learning model to predict a fault. For example, a client device may capture and/or determine test audio data. The test audio data may be sent to the server, which may perform analysis on the test audio data. For example, the server may provide the test audio data to the machine learning model. The machine learning model on the server may predict a fault based on the test audio data. For example, the machine learning model on the server may classify the test audio data as predicting a fault or as not predicting a fault. In a case that a fault is predicted, the server may produce and/or a send a predicted fault alert. For example, the server may present a predicted fault alert and/or may send the predicted fault alert to a client device and/or to an apparatus.

In some examples, the machine learning model may utilize input data about the origin of the audio data (e.g., which of a plurality of sensors or audio inputs captured the corresponding audio signal) and/or operating state. In some examples, the machine learning model may output a label (e.g., normal, abnormal, or unknown) and a likelihood (e.g., confidence level) corresponding to the label. The label and/or likelihood may be utilized to determine whether to send a predicted fault alert. The predicted fault alert may be sent to the apparatus.

In some examples, a client device may send a predicted fault alert. For example, in a case that the test audio data indicates a predicted fault (e.g., if the test audio is classified as predicting a fault or if the likelihood that a fault will occur is above a threshold (e.g., 50%)) the client device may send a predicted fault alert. A predicted fault alert is information (e.g., a message, signal, indicator, data, etc.) that indicates a predicted fault. The apparatus may receive the predicted fault alert from the client device based on the trained machine learning model. For example, the client device may utilize the trained machine learning model to predict a fault, and may send a predicted fault alert to the apparatus.

In some examples, the apparatus may identify a set of service events corresponding to a previously unidentified type of fault. Selecting 104 the portion of the audio data may be based on the set of service events. For example, the service event data may indicate a previously unidentified type of fault (e.g., different part failure). The apparatus may identify a set of service events that correspond to the previously unidentified fault. For example, the apparatus may maintain a database of service event data, and may search the database for service events matching the previously unidentified fault. The apparatus may select a portion or portions of audio data corresponding to the service events of the previously unidentified fault. The portion or portions of audio data may be utilized to train 106 the machine learning model (e.g., update training for the machine learning model). In some examples, the apparatus may transmit the updated (e.g., re-trained) machine learning model to the client devices. Accordingly, the machine learning model may be updated or re-trained as new types of faults arise.

In some examples, if a fault occurs that is not identified by the apparatus, an analysis may be performed in order to attempt to identify the fault by sound. For example, the apparatus and/or a client device may perform an analysis of audio data and/or an audio signal in order to determine characteristics of the audio data that indicate, correspond to, and/or correlate with a fault. The characteristics (e.g., an audio signature) may be utilized in order to update and/or re-train the machine learning model.

In some examples, a client device or type of client device may operate in a plurality of operating states. An operating state is a state or mode of operation for a device. In an example, the client devices may be a plurality of printers. In some examples, a printer may operate in accordance with multiple operating states, including an idle state, a pre-heat state, a test rollers state, a paper retrieval state, a toner application state, a fusing state, and a paper ejection state. For instance, the pre-heat state and test rollers state may occur during printer warm-up. The paper retrieval state, toner application state, fusing state, and paper ejection state may occur during printing a page. Some printers may have other operating states, and other devices may have other operating states. Each operating state may be characterized by different vibrations and/or audio. For example, parts of the audio data may respectively correspond to a plurality of operating states of the client device or devices. For instance, the parts of the audio data may include a part or parts (e.g., subsets of the audio data) corresponding to an idle state, a pre-heat state, a test rollers state, a paper retrieval state, a toner application state, a fusing state, and/or a paper ejection state.

In some examples, the machine learning model may include an input corresponding to an operating state of a client device, where the client device operates in a plurality of operating states. For example, the apparatus may receive operating state data from a client device or client devices, where operating state data indicates operating states. In some examples, the audio data may be tagged with operating state data, and/or the operating state data may indicate parts of the audio data corresponding to the operating states. In some examples, the apparatus may train 106 the machine learning model using the operating state data. For instance, the apparatus may train the machine learning model with different operating states and parts of the audio data corresponding to the different operating states. This may enable a client device to utilize operating state data and corresponding parts of audio data as inputs to the trained machine learning model to predict a fault.

In some examples, the apparatus may train 106 a plurality of machine learning models, where each of the plurality of machine learning models corresponds to an operating state of a client device. For example, each of the machine learning models that corresponds to an operating state may be trained with a part of the audio data that corresponds to that operating state. Accordingly, there may be a machine learning model for each operating state of a client device. The apparatus may send the machine learning models to the client devices. For example, the machine learning model(s) may be sent in an update procedure (e.g., regular software update). A client device may apply a respective machine learning model for each operating state (using corresponding audio data) to predict a fault for each operating state.

In some examples, the method 100 (or an operation or operations of the method 100) may be repeated over time. For example, service event data and audio data may be periodically received and the machine learning model may be periodically re-trained or refined.

FIG. 2 is a block diagram of an example of an apparatus 202 that may be used in fault prediction model training with audio data. The apparatus 202 may be an electronic device, such as a personal computer, a server computer, a printer, a 3D printer, a smartphone, a tablet computer, etc. The apparatus 202 may include and/or may be coupled to a processor 204 and/or a memory 206. In some examples, the apparatus 202 may be in communication with (e.g., coupled to, have a communication link with) a remote client device or remote client devices. The apparatus 202 may include additional components (not shown) and/or some of the components described herein may be removed and/or modified without departing from the scope of this disclosure.

The processor 204 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., training instructions 212) stored in the memory 206. Additionally or alternatively, the processor 204 may include an electronic circuit or circuits that include electronic components for performing a function or functions of the instructions (e.g., training instructions 212). In some examples, the processor 204 may be configured to perform one, some, or all of the functions, operations, elements, methods, etc., described in connection with one, some, or all of FIGS. 1-5.

The memory 206 may be any electronic, magnetic, optical, or other physical storage device that contains or stores electronic information (e.g., instructions and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 206 may be a non-transitory tangible machine-readable storage medium, where the term “non-transitory” does not encompass transitory propagating signals. In some examples, the memory 206 may include multiple devices (e.g., a RAM card and a solid-state drive (SSD)).

In some examples, the apparatus 202 may include a communication interface (not shown in FIG. 2) through which the processor 204 may communicate with an external device or devices (not shown), for instance, to receive and store information (e.g., support case data 208 and/or sound data 210) corresponding to a remote client device or remote client devices. The communication interface may include hardware and/or machine-readable instructions to enable the processor 204 to communicate with the external device or devices. The communication interface may enable a wired or wireless connection to the external device or devices. The communication interface may further include a network interface card and/or may also include hardware and/or machine-readable instructions to enable the processor 204 to communicate with various input and/or output devices, such as a keyboard, a mouse, a display, another apparatus, electronic device, computing device, etc., through which a user may input instructions and/or data into the apparatus 202.

In some examples, the memory 206 may store support case data 208. A support case is a record of a service event. For example, support case data 208 may include service event information. The support case data 208 may be obtained (e.g., received) from an external device (e.g., client device or other device) and/or may be generated on the apparatus 202. For example, the processor 204 may execute instructions (not shown in FIG. 2) to receive the support case data 208 from an external device. Additionally or alternatively, support case data 208 may be input to the apparatus via a user interface.

In some examples, the memory 206 may store sound data 210. Sound data 210 is data that is based on audible vibrations. Sound data 210 is one example of audio data. The sound data 210 may be obtained (e.g., received) from an external device (e.g., client device or other device). For example, the processor 204 may execute instructions (not shown in FIG. 2) to receive the sound data 210 from remote client devices. The sound data 210 may correspond to remote client devices. For example, the sound data 210 may be collected and/or produced based on audio signals captured by a sensor or sensors as described in connection with FIG. 1.

In some examples, the processor 204 may retrieve a portion of the sound data 210 from the memory 206 based on the support case data 208. For example, the processor 204 may retrieve a portion of the sound data 210 from within a time period before a service event or fault occurred. In some examples, retrieving the portion of sound data 210 may include locating a set of audio signatures in the sound data 210 corresponding to a type of support case. For instance, support cases may be categorized in accordance with a type. A type of support case is a category based on a common factor. For example, different types of support cases may correspond to different faults, different part failures, different degraded performances, different actions taken to remedy the fault, different operating states, different types of client devices, etc.

In some examples, the processor 204 may execute the training instructions 212 to train a machine learning model to predict a fault based on the portion (e.g., a first portion) of the sound data 210. Training the machine learning model may be accomplished as described in connection with FIG. 1.

In some examples, the processor 204 may validate the machine learning model based on a second portion of the sound data 210. For example, the second portion of the sound data 210 may include sound data 210 corresponding to a positive and/or negative sample(s). For instance, the second portion of the sound data 210 may include sound data 210 corresponding to support cases of the same type (e.g., with the same or similar faults or remedies, etc.) as the support cases corresponding to the first portion of sound data 210. Other sound data 210 that corresponds to normal remote client device operation (e.g., sound data 210 where a fault did not occur) may also be used to validate the machine learning model. In some examples, the processor 204 may validate the trained machine learning model by applying the second portion of the sound data 210 to the trained machine learning model to determine whether the trained machine learning model correctly classifies the second portion of the sound data 210 as corresponding to instances where faults occurred. The processor 204 may validate the trained machine learning model in a case that the trained machine learning model satisfied a validation criterion. An example of the validation criterion is an accuracy threshold. For instance, if the accuracy of the trained machine learning model satisfies the accuracy threshold (e.g., 90% accuracy, 95% accuracy, etc.), the validation criterion is satisfied.

In some examples, the processor 204 may send the machine learning model to the remote client devices in a case that the machine learning model satisfies the validation criterion. In a case that the machine learning model does not satisfy the validation criterion, the processor 204 may not send the machine learning model and/or may perform additional training to improve (e.g., improve the accuracy of) the machine learning model.

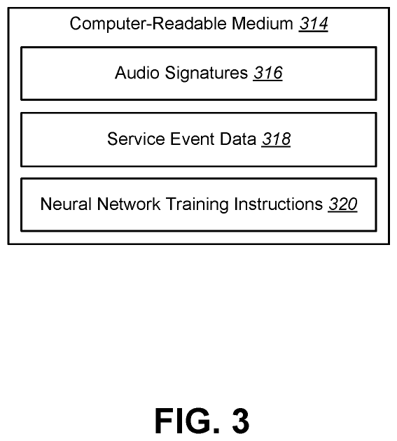

FIG. 3 is a block diagram illustrating an example of a computer-readable medium 314 for performing fault prediction model training with audio data. The computer-readable medium is a non-transitory, tangible computer-readable medium 314. The computer-readable medium 314 may be, for example, RAM, EEPROM, a storage device, an optical disc, and the like. In some examples, the computer-readable medium 314 may be volatile and/or non-volatile memory, such as DRAM, EEPROM, MRAM, PCRAM, memristor, flash memory, and the like. In some implementations, the memory 206 described in connection with FIG. 2 may be an example of the computer-readable medium 314 described in connection with FIG. 3.

The computer-readable medium 314 may include code (e.g., data and/or instructions). For example, the computer-readable medium 314 may include audio signatures 316, service event data 318, and/or neural network training instructions 320.

The audio signatures 316 include information that characterizes audio signals as described in connection with FIG. 1. The service event data 318 is data indicating a service event and/or information about a service event as described above in connection with FIG. 1.

The neural network training instructions 320 may include code to cause a processor to determine selected audio signatures corresponding to a service event from a set of audio signatures 316 corresponding to client devices. For example, the code may cause a processor to select audio signatures corresponding to an operating state of a client device, audio signatures corresponding to a particular client device, audio signatures in a period of time relative to the service event, audio signatures corresponding to a type of service event, and/or audio signatures corresponding to a type of client device.

The neural network training instructions 320 may also include code to cause the processor to train a neural network to classify audio as indicating a potential fault based on the selected audio signatures. This may be accomplished as described in connection with FIGS. 1 and 2. For example, the neural network training instructions 320 may cause a processor to adjust weights of a neural network (or neural networks) to classify audio (e.g., audio data) as indicating a potential fault or not.

In some examples, other kinds of machine learning models may be trained and utilized instead of a neural network. As described above, examples of machine learning models include classification algorithms (e.g., supervised classifier algorithms), artificial neural networks, decision trees, random forests, support vector machines, Gaussian classifiers, KNN, including combinations thereof, etc. For example, a machine learning classification model may be trained and/or utilized.

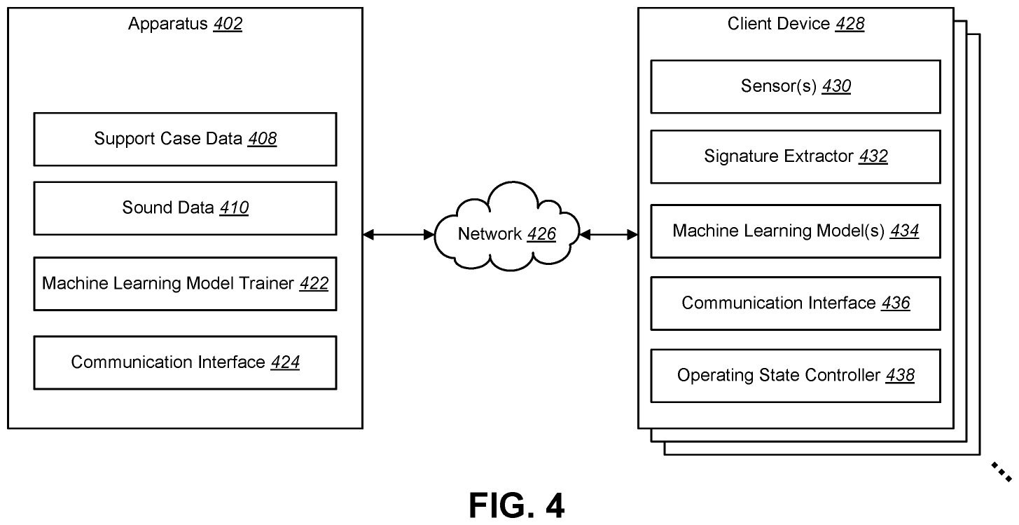

FIG. 4 is a block diagram illustrating an example of an apparatus 402 and a plurality of client devices 428. The apparatus 402 may be an example of the apparatus 202 described in connection with FIG. 2. The apparatus 402 may include a processor and memory. The apparatus 402 may include support case data 408, sound data 410, a machine learning model trainer 422, and/or a communication interface. The support case data 408, sound data 410, and/or machine learning model trainer 422 may be examples of corresponding elements described in connection with FIG. 2. For example, the support case data 408 and the sound data 410 may be stored in memory. The machine learning model trainer 422 may be implemented in hardware (e.g., circuitry) or a combination of hardware and software (e.g., a processor with instructions in memory). The communication interface 424. The communication interface 424 may include hardware and/or machine-readable instructions to enable the apparatus 402 to communicate with the client devices 428 via a network 426. The communication interface 424 may enable a wired or wireless connection to the client devices 428.

The client devices 428 may each include a processor and memory (e.g., a computer-readable medium). Each of the client devices 428 may include a sensor or sensors 430, a signature extractor 432, a machine learning model or models 434, a communication interface 436, and/or an operating state controller 438. In some examples, instructions or code for the signature extractor 432, machine learning model(s) 434, and/or operating state controller 438 may be stored in the memory (e.g., computer-readable medium) and may be executable by the processor. Each communication interface 436 may include hardware and/or machine-readable instructions to enable the client devices 428 to communicate with the apparatus 402 via the network 426. The communication interface 436 may enable a wired or wireless connection to the apparatus 402.

The sensor(s) 430 may capture or sense vibrations that are caused by the operation of the client device 428. Examples of the sensor(s) 430 include vibration sensors and microphones. In some examples, the sensor(s) 430 may convert mechanical vibrations and/or acoustical vibrations (e.g., sound waves) into an electronic audio signal or signals. For instance, the sensor(s) 430 may convert the vibrations into an electronic audio signal, which may be sampled and/or recorded by the client device 428.

The signature extractor 432 may extract an audio signature or signatures from the audio signal(s). For example, the signature extractor 432 may perform processing and/or transformation(s) to characterize an audio signal as an audio signature. In some examples, the signature extractor 432 may determine frequency peaks, signal envelopes, wave periods, energy distribution, etc., of the audio signal(s). In some examples, it may be beneficial to convert the audio signal(s) to audio signature(s) for transmission to the apparatus 402 to reduce the bandwidth for transmission and/or for privacy of the audio signal(s) captured by the client devices 428. The client device 428 may send audio signatures to the apparatus 402 via the network 426. In some examples, the signature extractor 432 may be implemented in hardware (e.g., circuitry) or a combination of hardware and software (e.g., a processor with instructions in memory).

In some examples, the client device 428 may include an operating state controller 438. The operating state controller 438 may control and/or detect the operating states of the client device 428. For example, the operating state controller 438 may indicate when the client device 428 is in a particular operating state. In some examples, the audio signatures may be tagged, categorized, or indicated as corresponding to a particular operating state. For example, audio signatures corresponding to times when the client device 428 is in a particular operating state may be tagged, categorized, and/or indicated as corresponding to that particular operating state. The client device 428 may operate in accordance with a plurality of different operating states. Each operating state may differ by a different functionality performed and/or mechanism utilized in each operating state. For example, rollers may behave differently while in a test rollers state than when in a toner application state for a printer. In some examples, the operating state controller 438 may be implemented in hardware (e.g., circuitry) or a combination of hardware and software (e.g., a processor with instructions in memory).

The machine learning model(s) 434 may be stored in memory and/or may be executed by a processor to perform fault prediction. The machine learning model(s) 434 may be trained by the apparatus 402 (e.g., the machine learning model trainer 422) and may be received from the apparatus 402. In some examples, the client device 428 may utilize the machine learning model(s) 434 to classify audio as indicating a potential fault. For example, the client device 428 may determine whether an audio signature or signatures predict a fault of the client device 428. For instance, the machine learning model(s) 434 may predict whether a fault is likely to occur based on the audio signature(s) (e.g., test audio signatures), which characterize the operation of the client device 428 by the vibrations and/or sounds of the client device 428.

In a case that the machine learning model(s) 434 indicate that a fault is likely to occur (with a likelihood that is greater than a threshold, for example), the client device 428 may transmit a predicted fault alert to the apparatus 402 (in response to classifying audio or an audio signature as indicating a potential fault, for instance). For example, the predicted fault alert may be transmitted to the apparatus 402 using the communication interface 436 via the network 426.

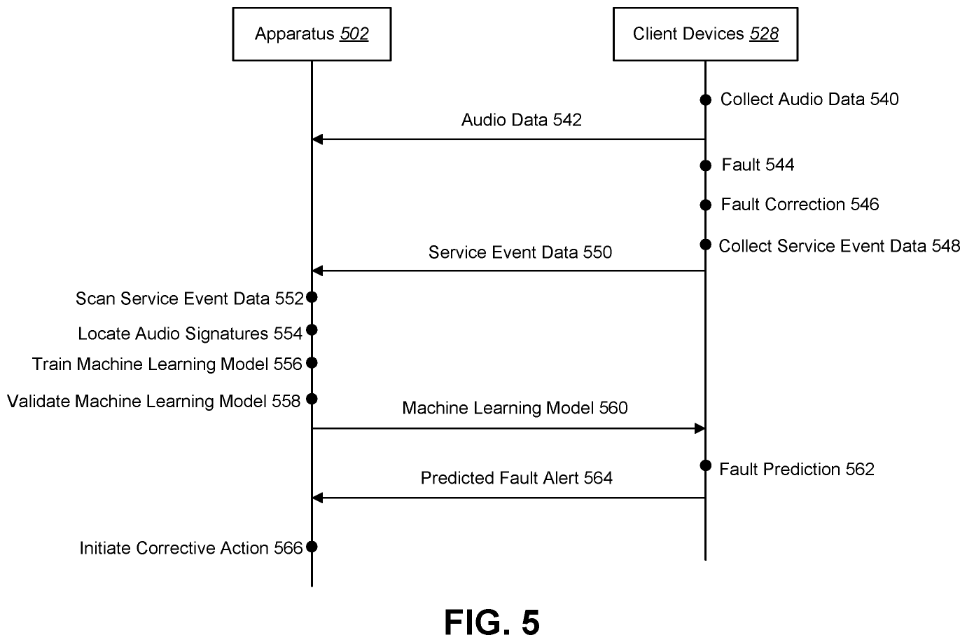

FIG. 5 is a thread diagram of an example of an apparatus 502 and client devices 528. The apparatus 502 may be an example of the apparatuses 202, 402 described herein. The client devices 528 may be an example of the client devices 428 described herein.

In this example, the client devices collect audio data 540. For example, the client devices 528 may periodically or continuously collect audio data 540. The client devices 528 may transmit the audio data 542 to the apparatus. For instance, the audio data may include audio signatures. In this example, a fault 544 occurs with a client device or client devices 528. Fault correction 546 also occurs. For example, a technician may remedy the fault, a user may replace a failed part, and/or support personnel may remotely or locally fix the fault. In this example, the client device or devices 528 collect service event data 548. In other examples, another device may collect the service event data.

The client device or client devices 528 may transmit the service event data 550 to the apparatus 502. The apparatus 502 may scan the service event data 552. For example, the apparatus 502 may determine service events corresponding to the same or similar faults. The apparatus 502 may locate audio signatures 554 corresponding to the service events (e.g., the determined service events). For example, the apparatus 502 may locate audio signatures 554 within a period of time preceding the fault (and/or that correspond to a particular operating state when the fault occurred or that is related to the fault, for example).

The apparatus 502 may train a machine learning model 556. For example, the apparatus 502 may train the machine learning model 556 to classify the received audio signatures as indicating a fault. The apparatus 502 may validate the machine learning model 558. For example, the apparatus 502 may utilize other audio signatures corresponding to the same or similar type of fault to determine the accuracy of the machine learning model. In a case that the machine learning model meets a validation criterion, the apparatus 502 transmits the machine learning model 560 to the client devices 528.

The client devices 528 may utilize the machine learning model 560 to perform fault prediction 562. For example, as more audio data (e.g., audio signatures) are collected, the client devices 528 may utilize the audio data as an input to the machine learning model to determine whether a fault is predicted (e.g., likely to occur). In a case that a fault is predicted (e.g., is predicted with some threshold likelihood), a client device 528 may send a predicted fault alert 564 to the apparatus 502.

The apparatus 502 may initiate corrective action 566 based on the predicted fault alert. Initiating corrective action may include performing an action to remedy the predicted fault before the predicted fault occurs. Examples of corrective action initiation may include sending instructions to a client device and/or to personnel associated with a client device. For example, the apparatus 502 may send instructions to the client device 528 to reconfigure to avoid the fault. Additionally or alternatively, the apparatus 502 may send instructions to a service provider (e.g., service technician) indicating that a fault is predicted for a particular client device and/or that maintenance is needed. In some examples, the instructions may indicate the nature of the predicted fault (e.g., a part that is expected to fail) and/or the type of maintenance that needs to be performed (e.g., parts need to be replaced, cleaned, lubricated, reconfigured, etc.). In some examples, initiating the corrective action 566 may include scheduling maintenance (e.g., requesting a time for maintenance from an owner of the client device 528 that is likely to experience a fault). Other corrective actions may be initiated in other examples.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
receiving service event data and audio data corresponding to client devices;
selecting a portion of the audio data based on the service event data; and
training a machine learning model for fault prediction based on the portion of audio data.

2. The method of claim 1, further comprising transmitting the trained machine learning model to the client devices.

3. The method of claim 2, further comprising receiving a predicted fault alert from a client device based on the trained machine learning model.

4. The method of claim 1, wherein selecting the portion of the audio data comprises selecting a first portion of the audio data within a period of time from a service event.

5. The method of claim 1, wherein the machine learning model comprises an input corresponding to an operating state of a client device, wherein the client device is to operate in a plurality of operating states.

6. The method of claim 1, further comprising training a plurality of machine learning models including the machine learning model, wherein each of the plurality of machine learning models corresponds to an operating state of a client device.

7. The method of claim 1, wherein parts of the audio data respectively correspond to a plurality of operating states of the client devices.

8. The method of claim 7, wherein the parts of the audio data comprise at least one subset corresponding to an idle state, a pre-heat state, a test rollers state, a paper retrieval state, a toner application state, a fusing state, or a paper ejection state.

9. The method of claim 1, wherein the client devices are a plurality of printers.

10. The method of claim 1, further comprising identifying a set of service events corresponding to a previously unidentified type of fault, and wherein the selecting the portion of the audio data is based on the set of service events.

11. An apparatus, comprising:
a memory to store support case data and sound data corresponding to remote client devices;
a processor coupled to the memory, wherein the processor is to:
retrieve a portion of the sound data from the memory based on the support case data; and
train a machine learning model to predict a fault based on the portion of the sound data.

12. The apparatus of claim 11, wherein retrieving the portion of the sound data comprises locating a set of audio signatures in the sound data corresponding to a type of support case.

13. The apparatus of claim 11, wherein the processor is to:
validate the machine learning model based on a second portion of the sound data; and
send the machine learning model to the remote client devices in a case that the machine learning model satisfies a validation criterion.

14. A non-transitory tangible computer-readable medium storing executable code, comprising:
code to cause a processor to receive a machine learning model that is trained based on selected audio signatures corresponding to a service event; and
code to cause the processor to utilize the machine learning model to classify audio as indicating a potential fault.

15. The computer-readable medium of claim 14, further comprising code to cause the processor to transmit a predicted fault alert in response to classifying the audio as indicating the potential fault.
